(19) United States
(12) Patent Application Publication
(10) Pub. No.: US 2004/0007618 A1
(43) Pub. Date: Jan. 15, 2004

(54) Prepaid credit card method

(76) Inventors: Scott Oram, El Cajon, CA (US); Robert Oram, El Cajon, CA (US)

Correspondence Address: Scott Oram, 9649 Palemino Ridge Dr., El Cajon, CA, 92021, US

(21) Appl. No.: 10/192,997

(22) Filed: Jul. 10, 2002

(51) Int. Cl. G06K 5/00

(52) U.S. Cl. 235/380

(57) ABSTRACT

Methods for distributing and activating prepaid credit cards are presented. The prepaid credit cards are made available to consumers in various locations including retail outlets, department stores, financial institutions, and other convenient places. Consumers purchase a prepaid credit card in a desired denomination and then activate the card. The card can be activated over the phone, in combination with a purchase, or at a special kiosk. Once the card has been activated, the consumer can use the card as a normal credit or debit card. When the initial value of the card is depleted, the card can be refilled with additional funds.

### BACKGROUND

1. Field of the Invention

The present invention generally relates to prepaid credit cards and more particularly relates to methods of using prepaid credit cards.

2. Related Art

In the recent past, prepaid credit cards have appeared on the scene as an alternative to conventional unsecured credit cards. These prepaid credit cards function as a debit card, where the transaction amount is debited from an existing balance. Particular niche markets have developed for prepaid credit cards, for example students (and parents of students) have adopted prepaid credit cards for convenience of use and as a way to introduce responsible credit card management and use.

Conventional prepaid credit cards come in a variety of different types. One popular type is similar to the conventional prepaid phone card. These types of cards are typically purchased in predetermined fixed amounts, for example, $25, $50, $100, etc. The cards may be purchased with cash, money orders, credit cards, or other types of currency or check. Sometimes, the cards may be sold at a price that is higher than the face value of the prepaid card to provide the retailer with a profit margin or to recoup the cost of producing the physical card, packaging, and distribution costs.

In addition to providing the ability to purchase items with the card, some conventional prepaid credit cards also include loyalty incentives such as a point program whereby the purchaser gains points for use of the card or for use of the card in particular establishments.

Newer types of the conventional prepaid credit card are indistinguishable from a conventional credit card. Typically, these newer prepaid credit cards are “reloadable” so that additional finds can be transferred into an account that serves as the balance account for the card. Such an account and card combination is more accurately called a debit card and account. A significant drawback of these conventional prepaid credit cards (more accurately, debit cards) is that they do not allow the user to establish any credit history. Such is true for all of the conventional types of debit cards.

Therefore, what is needed is a prepaid credit card process that overcomes these significant problems found in the conventional systems as described above.

### SUMMARY

The prepaid credit card process allows a consumer to purchase a card in a predetermined denomination. The consumer can then activate the card by making a purchase with the card. When making the activating purchase, the consumer provides the merchant with the prepaid card and a personal identification number (“PIN”) obtained from the prepaid card packaging. The merchant is equipped with a point-of-sale terminal that will activate the card. Activation is carried out by sending information read from the magnetic strip on the card to a processing center along with the PIN. Once the card has been activated, it can be used as a regular credit/debit card for purchases in any location that accepts these types of cards.

Alternatively, the consumer can purchase a card in the desired denomination and then activate the card at a particular kiosk or terminal that prompts the consumer to enter in a PIN selected by the consumer. Activation is carried out by sending information read from the magnetic strip on the card to a processing center along with the selected PIN. Once the card has been activated, it can be used as a normal credit card or debit card for purchases at any location that accepts these types of cards.

Another method for activating the card allows the consumer to place a telephone call to a specific toll free number that prompts the consumer to enter in the card number along with a PIN selected by the consumer.

Once the initial value of the card has been depleted, the card can be refilled with additional funds through a subsequent activation process carried out over the telephone, in combination with a purchase, or at a special kiosk.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a front view of an example prepaid credit card according to an embodiment of the present invention;

FIG. 2 is a back view of an example prepaid credit card according to an embodiment of the present invention;

FIG. 3 is a high level network diagram illustrating an example activation network according to an embodiment of the present invention;

FIG. 4 is a flow diagram illustrating an example process for using a prepaid credit card according to an embodiment of the present invention;

FIG. 5 is a flow diagram illustrating an example process for activating a prepaid credit card at a merchant location according to an embodiment of the present invention;

FIG. 6 is a flow diagram illustrating an example process for activating a prepaid credit card at a financial institution according to an embodiment of the present invention; and

FIG. 7 is a flow diagram illustrating an example process for activating a prepaid credit card using a touch tone telephone according to an embodiment of the present invention.

### DETAILED DESCRIPTION

Certain embodiments as disclosed herein provide for prepaid credit card processes. For example, one method as disclosed herein allows for a consumer to purchase a prepaid credit card in a desired denomination and then use that card as a normal credit or debit card after the card has been activated.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

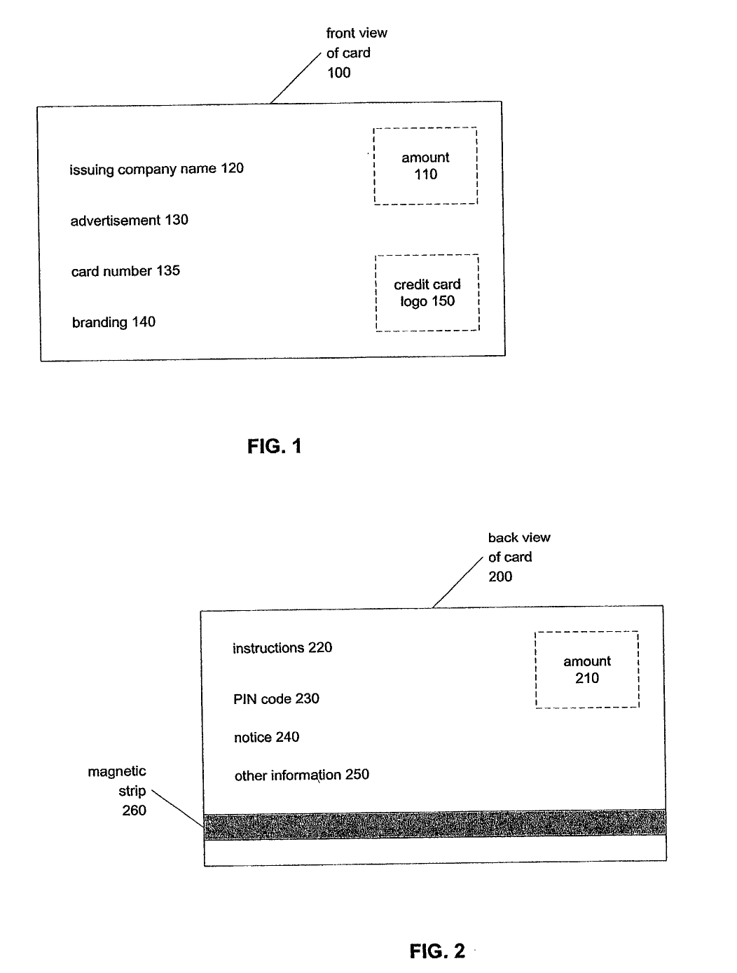

FIG. 1 is a front view of an example prepaid credit card 100 according to an embodiment of the present invention. In the illustrated embodiment, there are several discrete areas or regions on the front of the card that are used to present different types of information. First, the amount 110 of the card is presented in the upper right hand corner. It should be noted at this point that the various discrete regions can be placed at locations on the card other than those places identified in the illustrated embodiment. The function of the discrete regions is to provide information. That being stated, there can be more or less regions presented on the front of the card in order to effectively and efficiently provide information to the consuming public.

Also presented on the front of the card 100 is the issuing company name 120, an advertisement 130, the card number 135, and branding 140. Additionally, a credit card logo 150 can be displayed on the front of the card 100. Advantageously, the issuing company name 120 allows different companies to market their own services through the use of the card. For example, a favorite convenience store or a financial institution might place their company name here. The advertisement 130 region can be used for any type of advertisement, the card number 135 can be printed on the card or embossed into the material of the card, and the branding 140 region is preferably used to display the brand of the overall maker and provider of the prepaid card, such as Pay$World.

FIG. 2 is a back view of an example prepaid credit card 200 according to an embodiment of the present invention. In the illustrated embodiment, there are several discrete areas or regions on the back of the card that are used to present different types of information. First, the amount 210 of the card is presented in the upper right hand corner. It should be noted at this point that the various discrete regions can be placed at locations on the back of the card other than those places identified in the illustrated embodiment. The function of the discrete regions is to provide information. That being stated, there can also be more or less regions presented on the back of the card in order to effectively and efficiently provide information to the consuming public.

In the illustrated embodiment, the back of the card 200 also includes instructions 220 and the PIN code 230. These two pieces of information advantageously provide a consumer with all of the information needed to activate the card. For example, the instructions preferably include a telephone number that the consumer can call in order to activate the card. During the activation process, the consumer is asked to provide the PIN code from PIN code region 230. The instructions may also contain information pertaining to activation of the card at a merchant location or a financial institution.

In addition, the back of the card 200 in the illustrated embodiment contains a notice 240 region and an other information 250 region. These regions 240 and 250 can be used to provide legal notices and other types of information to the consuming public. For example, the legal ramifications of activation and use of the card may be provided along with certain intellectual property information.

Finally, the illustrated embodiment includes a magnetic strip 260 on the back of the card 200. The magnetic strip 260 advantageously is configured to store information pertaining to the prepaid card. For example, the magnetic strip may be preprogrammed with the card number, the PIN code, and the denomination or amount of the card.

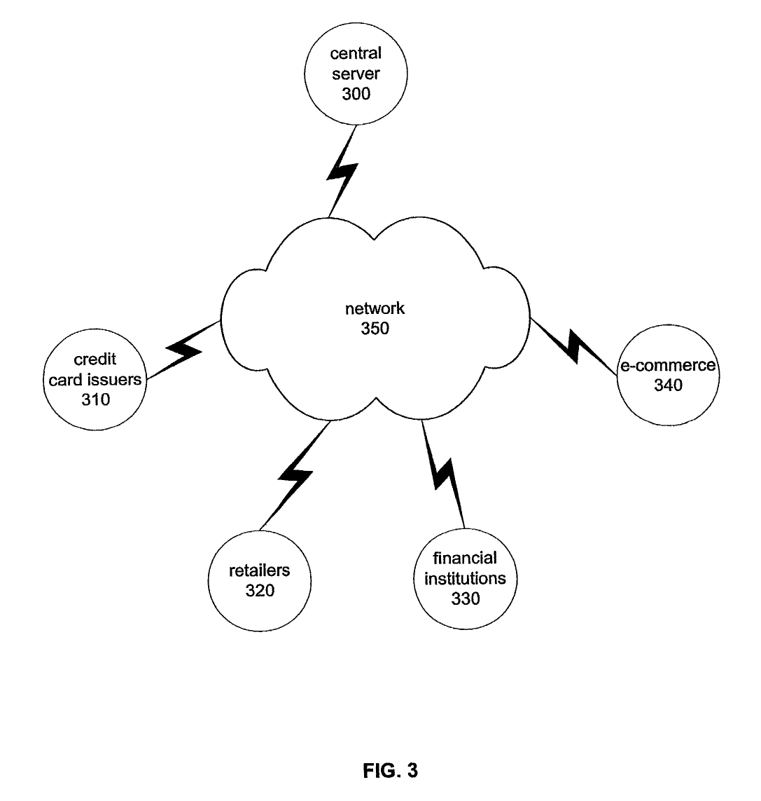

FIG. 3 is a high level network diagram illustrating an example activation network 350 according to an embodiment of the present invention. The activation network 350 preferably links up a variety of activation points with a central server 300. The network 350 can be any type of communication network or combinations thereof.

In the illustrated embodiment, various types of activation points include credit card issuers 310, retailers 320, financial institutions 330, and e-commerce locations 340. Additional types of activation points are also contemplated, including telephone ordering service providers, catalogues, department stores, and the like. For example, credit card issuers 310 may have a kiosk location in a shopping mall. At the kiosk location, a consumer is able to purchase and activate the prepaid card. Similarly, retailers 320 and financial institutions 330 can have physical locations where a consumer can purchase and activate the prepaid card.

Furthermore, e-commerce 340 providers can have a secure web site where cards can be ordered and activated. In such an on-line embodiment, a consumer may order the prepaid card for delivery by mail. Upon receiving the card, the consumer can then return to the e-commerce 340 provider to activate the card. Additionally, the consumer may receive the card number and PIN number via electronic communication (e.g. email) immediately after ordering the card from the e-commerce 340 provider. The consumer may then activate the card immediately, although this may be unwise for security purposes.

As illustrated, each of the locations is communicatively linked to the central server 300 over the network 350. Advantageously, this allows the locations to send an activation request to the central server over the network 300. Additionally, it allows the locations to receive an activation confirmation from the central server 300.

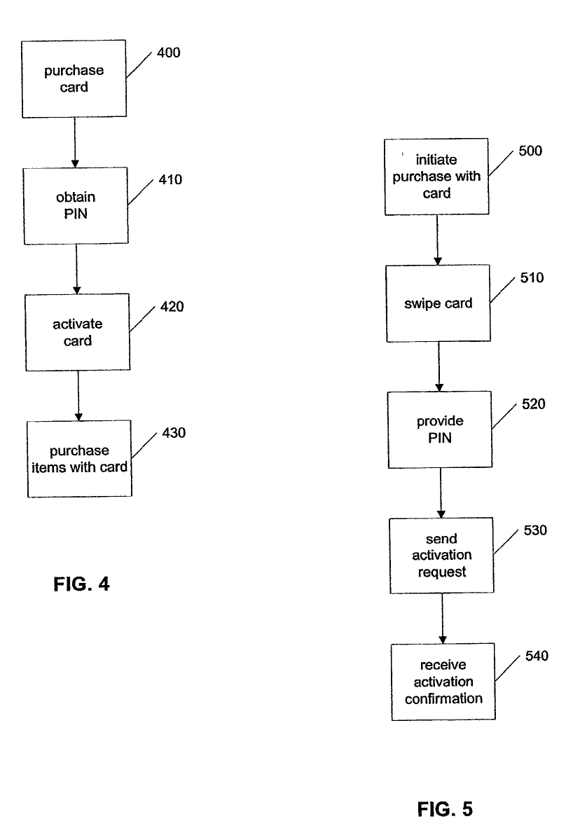

FIG. 4 is a flow diagram illustrating an example process for using a prepaid credit card according to an embodiment of the present invention. Initially, instep 400, a consumer purchases the card. The card may be purchased at a variety of locations, including department stores, financial institutions, over the phone, over the web, and through a catalogue, just to name a few. Once the card is purchased, the consumer obtains the PIN, as shown in step 410. The PIN can advantageously be integrated with the packaging of the card or the PIN may be included on the card itself. For example, the PIN may be printed on the card underneath an opaque covering that can be scratched off to reveal the PIN, much like a lottery card can be scratched.

After the PIN has been obtained, the consumer can activate the card, using the PIN and the card number combination. The card number can be stored in the magnetic strip of the card or embossed into the material of the card. Once the card has been activated, the consumer can purchase items with the card just as if using a conventional credit card or debit card.

FIG. 5 is a flow diagram illustrating an example process for activating a prepaid credit card at a merchant location according to an embodiment of the present invention. First, the consumer begins the activation by initiating a purchase with the card, as shown in step 500. The merchant swipes the card as part of the purchase process and the card number is sent to the network for validation. Because the card has not been activated, the consumer is prompted to provide a PIN number. The consumer provides the PIN number in step 520, for example, by typing the number into the keypad of the point-of-sale (“POS”) terminal.

Once the PIN has been provided, the POS terminal sends an activation request over the network to the central server in step 530. After processing the request, the central server sends a response and the POS receives an activation confirmation, as shown in step 540. Once the card has been activated, the consumer can purchase items with the card just as if using a conventional credit card or debit card.

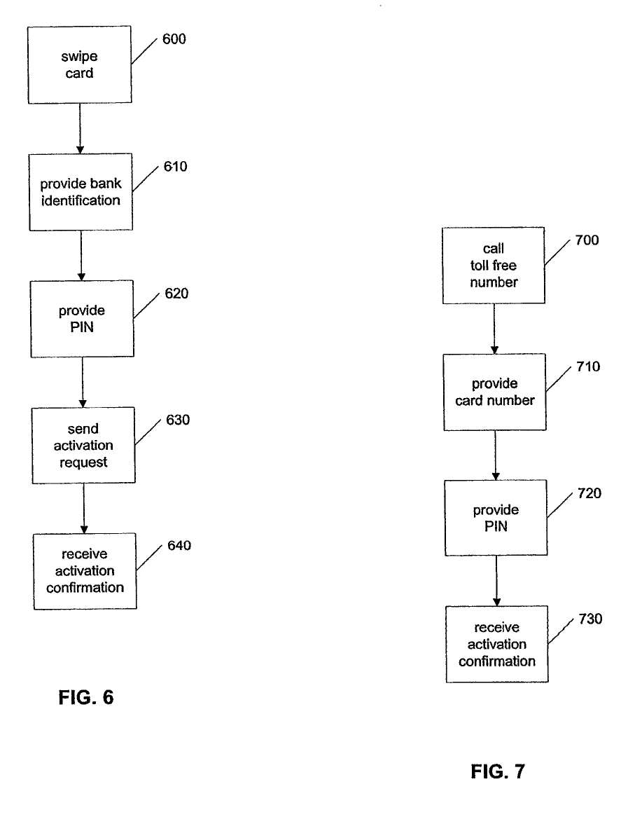

FIG. 6 is a flow diagram illustrating an example process for activating a prepaid credit card at a financial institution according to an embodiment of the present invention. First, the financial institution begins the activation by swiping the prepaid card, as shown in step 600. Next, the financial institution provides its identification number (e.g. its unique ACH number) in step 610. Because the card has not been activated, the financial institution is prompted to provide a PIN number. The PIN is obtained from the consumer and then provided in step 620. Once the PIN has been provided, the activation request is sent over the network to the central server, as illustrated in step 630. After processing the request, the central server sends a response and the financial institution receives an activation confirmation, as shown in step 640. Once the card has been activated, the consumer can purchase items with the card just as if using a conventional credit card or debit card.

Alternatively, all of the information provided to the central server can be entered into fields of an activation screen and once all of the information is collected, the activation request is sent to the central server Additionally, the consumer may also be able to provide a second PIN that is established at the central server as the PIN associated with the prepaid card. In this fashion, the consumer can customize and protect the PIN when the PIN is printed on the back of the card itself.

FIG. 7 is a flow diagram illustrating an example process for activating a prepaid credit card using a touch tone telephone according to an embodiment of the present invention. Initially, the consumer calls a telephone number to activate the card, as shown in step 700. The telephone number can be a toll free number and is preferably printed on the back of the card in one of the information areas or in the instructions area. Upon establishing a telephone call, the consumer provides the card number in step 710 and the PIN in step 720. Once the information has been provided, the operator sends an activation request and then provides the activation confirmation to the consumer, who receives the activation confirmation in step 730. After activation, the consumer can purchase items with the card just as if using a conventional credit card or debit card.

The activation process can also be altered to work in an online embodiment so that the consumer visits a secure web site and provides the card number and PIN (and perhaps a second PIN) information and then receives an activation confirmation. As previously described, once the card has been activated, the consumer can purchase items with the card just as if using a conventional credit card or debit card.

It is understood that the description and drawings presented herein represent presently preferred embodiments of the invention and are therefore representative of the subject matter which is broadly contemplated by the present invention. Thus, the scope of the present invention fully encompasses other embodiments and is accordingly limited by nothing other than the appended claims.

What is claimed is:

1. A method for activating a prepaid credit card, the method comprising:
providing a prepaid credit card to consumers at retail locations, the prepaid credit card having a card number and a personal identification number (PIN);
receiving, an activation request from a consumer who has purchased the prepaid credit card, the activation request comprising the card number and the PIN;
consulting a database of prepaid credit card numbers and PINs to determine if the activation request is valid; and
providing an activation confirmation.

2. The method of claim 1, wherein the card number is embossed on the card and stored in the magnetic strip.

3. The method of claim 1, wherein the PIN is printed on the card.

4. The method of claim 3, wherein the PIN is covered by a removable opaque material.

5. The method of claim 1, wherein the activation request is received via a point of sale terminal.

6. The method of claim 1, wherein the activation request is received via an activation kiosk.

7. The method of claim 1, wherein the activation request is received via a computer network.

8. The method of claim 1, wherein the activation request is received via a touch tone telephone.
